(19) United States
(12) Patent Application Publication
(10) Pub. No.: US 2005/0173323 A1
(43) Pub. Date: Aug. 11, 2005

(54) Designs for filtration systems within appliances

(76) Inventors: William J. Meuleners, Faribault, MN (US); Richard A. Kirchner, Apple Valley, MN (US); Karl Fritze, Denmark Township, MN (US); David M. Botts, Minnetrista, MN (US)

Correspondence Address: Thomas R. Payne;CUNO Incorporated, 400 Research Parkway, Meriden, CT, 06450-1018, US

(21) Appl. No.: 10/975,193

(22) Filed: Oct. 28, 2004

Related U.S. Application Data
(60) Provisional application No. 60/515,049, filed on Oct. 28, 2003.

(51) Int. Cl. B01D 27/02

(52) U.S. Cl. 210/184; 210/282

(57) ABSTRACT

Water filtration systems and methods for assembling appliances involve embedded water flow components such that space is preserved within the appliance. In particular, the components can be incorporated into an insulated structure of an appliance by placing the components into a mold or frame prior to or during the formation of the component. For example, the filtration unit components can be incorporated into a wall or door of an appliance by placing the components into a mold or frame prior to or during the formation of the component. A foam-in-place operation, or the like, embeds the water system component, or portions thereof, within the insulated structure such that there is intimate contact between an insulating foam and the components and the component cannot be removed without destroying the structural integrity of the foam.

### CROSS REFERENCE TO RELATED APPLICATIONS

The present application is a continuation-in-part of and claims priority under 35 U.S.C. 119(e) to U.S. Provisional Application Ser. No. 60/515,049, entitled “IMPROVED DESIGNS FOR FILTRATION SYTEMS WITHIN APPLIANCES”, filed Oct. 28, 2003, the disclosure of which is hereby incorporated by reference to the extent not inconsistent with the present disclosure.

### BACKGROUND OF THE DISCLOSURE

The present disclosure relates to the installation and application of filtration systems within appliances and, more specifically to space saving manufacturing techniques for appliances incorporating liquid filtration systems.

Liquid filtration systems, such as, for example, water filtration systems designed for use in the home such as those found in refrigerators and water coolers are increasingly used to remove contaminants from water supplies. Due to increasing quality and health concerns with regard to municipal and well-water supplies, the inclusion of water filtration systems in refrigerators, once considered a luxury feature, is now included as a standard feature in all but entry level refrigerator designs.

Generally, a refrigerator including such a residential water filtration system is first assembled as a functioning refrigerator and then the residential water filtration system is installed on an exterior surface of the refrigerator or more typically, on an internal surface of a refrigerated compartment, such that the water is appropriately chilled when dispensed. Generally, the residential water filtration system includes a distribution manifold configured to accept a prepackaged cartridge filter. A residential water supply line can be routed through the refrigerator wall and fluidly connected to the distribution manifold. Any electrical connections, such as those between a controller and supply or distribution valves, may also require interconnection through the refrigerator wall. These connections, either water or electrical, are generally placed piecemeal through the refrigerator walls due to space considerations. In addition to piecemeal placement of the various connections, the water filtration systems may be placed in difficult to access, out of the way locations, as refrigerator manufacturers try to limit the amount of refrigerated space lost to the water filtration system.

For the reasons cited above, installation of water filtration systems within appliances, such as refrigerators, can be a cumbersome, labor-intensive process. Also, the water filtration system can occupy significant amounts of usable storage space within the appliance.

### SUMMARY OF THE DISCLOSURE

The present disclosure provide water filtration systems and appliance assembly methods for preserving usable space available to the consumer by incorporating one or more components of the water filtration systems within the structural components of an appliance. For example, the water filtration systems components can be incorporated into an interior wall of an appliance by placing the components into a mold or frame prior to or during the formation of the wall. This foam-in-place operation, or the like, embeds the water system component, or portions thereof, within the foam such that the foam conforms to the shape of the component, or portion thereof, and the components cannot be removed without fracturing the structural integrity of the foam.

In some representative embodiments, a water flow component or a portion thereof is placed within the mold such that the water flow component, or portion thereof, is within the structural component and is occupying less internal usable storage space thereby freeing up more usable storage space for consumer use.

In some representative embodiments, a water filtration system can comprise a filter manifold generally with an inlet, one or more outlets, and connections for one or more filter cartridges along with the one or more filter cartridges for connection to at least one water flow component embedded within a structural component of an appliance.

Representative methods, include a method for embedding a water flow component, or a portion thereof, to allow a water component to be permanently embedded within a structural component of an appliance such that the water component occupies less internal usable storage space or external space on the appliance.

Other representative embodiments include a structural component for use in assembling appliances, which comprises a water flow component, or portion thereof, embedded within an insulating foam such that the water flow component does not occupies less internal or external space on an assembled appliance.

### BRIEF DESCRIPTION OF THE DRAWINGS

FIG. 1 is a perspective view of a representative embodiment of a bulkhead fitting.

FIG. 2 is a second perspective view of the bulkhead fitting of FIG. 1, viewed from the bottom relative to the view in FIG. 1 although the orientation in FIG. 1 may or may not correspond to the actual orientation within the appliance.

FIG. 3 is a side view of the bulkhead fitting of FIG. 1.

FIG. 4 is a plan view of the bulkhead fitting of FIG. 1 viewed from the bottom relative to the orientation shown in FIG. 1.

FIG. 5 is a plan view of the bulkhead fitting of FIG. 1 viewed from the top relative to the orientation shown in FIG. 1.

FIG. 6 is a section view of the bulkhead fitting of FIG. 1 taken along line 6-6 of FIG. 5.

FIG. 7 is a partially exploded, perspective view of a representative embodiment of a filtration system incorporating the bulkhead fitting of FIG. 1.

FIG. 8 is an alternative perspective view of the filtration system of FIG. 7 viewed from the bottom relative to the orientation shown in FIG. 7, although the orientation in FIG. 7 may or may not correspond with the actual orientation within the appliance.

FIG. 9 is a plan view of the filtration system of FIG. 7 viewed from the top relative to the orientation shown in FIG. 7.

FIG. 10 is a side view of the filtration system of FIG. 7.

FIG. 11 is a perspective view of the filtration system of FIG. 7.

FIG. 12 is a plan view of a manifold assembly from the filtration system of FIG. 7.

FIG. 13 is a section view of the manifold assembly of FIG. 12 taken along line 13-13 of FIG. 12.

FIG. 14 is a section view of the manifold assembly of FIG. 12 taken along line 14-14 of FIG. 12.

FIG. 15 is a perspective view of a pair of appliance liners with the bulkhead fitting of FIG. 1 and a water tank prior to a foam-in-place operation.

FIG. 16 is a section view of an appliance wall including the bulkhead fitting of FIG. 1 and the manifold assembly of FIG. 12 following a foam-in-place operation.

FIG. 17 is a perspective view of an appliance liner with the bulkhead fitting of FIG. 1 and a water tank prior to a foam-in-place operation.

FIG. 18 is a perspective view of an appliance liner including the bulkhead fitting of FIG. 1 and a heat exchanger/water tank prior to a foam-in-place operation.

FIG. 19 is a front, partial section view of an appliance.

FIG. 20 is a section view of an appliance door.

FIG. 21 is a front partial section view of an appliance.

### DETAILED DESCRIPTION OF THE PRESENTLY PREFERRED REPRESENTATIVE EMBODIMENTS

To preserve usable storage space available to the consumer while being able to provide filtered water, one or more components of a water filtration unit can be incorporated into the structural components of an appliance. In particular, the components can be incorporated into walls of the appliance by placing the components into a mold or frame prior to or during the formation of an appliance body or portions thereof. In particular, refrigerators or other appliances have walls that can be formed by blowing foam into a mold that forms an insulating partition within the appliance. The insulating element can be directly formed between panels of the appliance or for coupling with the visible panels of the appliance. In some representative embodiments, a bulkhead fitting can be mounted so as to interconnect distribution components within an appliance wall with filtration components located within an open interior usable storage space portion. Alternatively or additionally, a water reservoir or tank can be placed within the mold such that the water reservoir is within the partition and is not occupying usable storage space thereby freeing up the space for consumer use. In some representative embodiments, the water filtration system comprises a drain system that drains water from an overflow tray through the doors to an evaporation tray below the refrigerator or suitable drain connection. In additional or alternative representative embodiments, the water dispensing system includes a valve proximate the dispenser such that line pressure is maintained up to the dispenser nozzle.

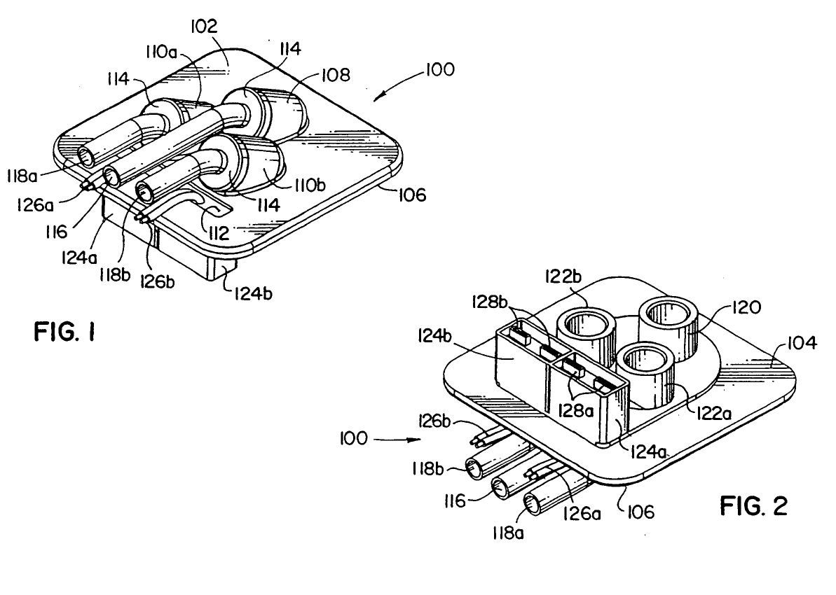

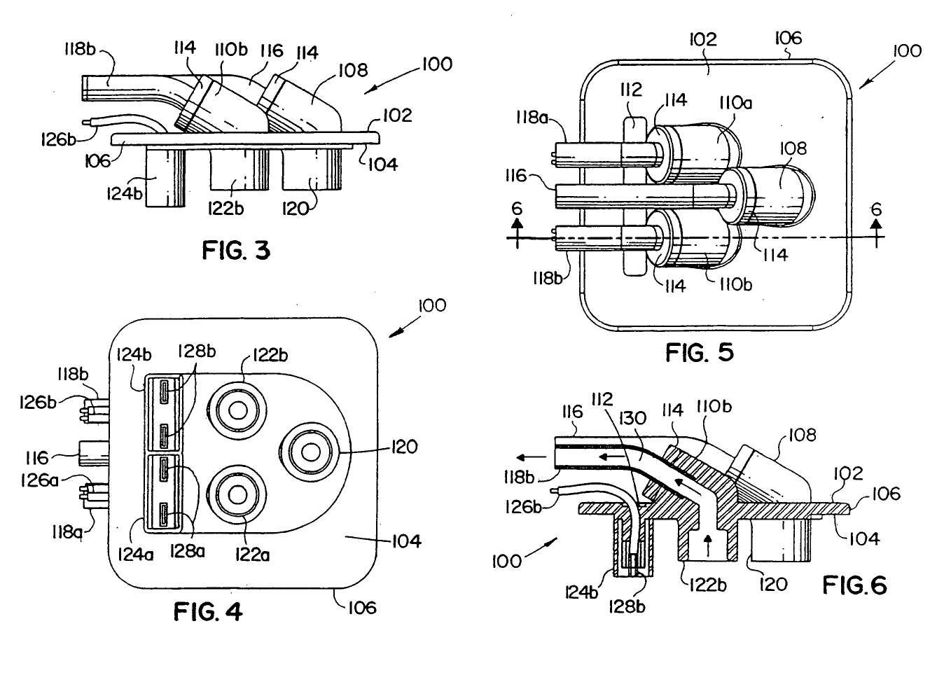

Depicted in FIGS. 1, 2, 3, 4, 5 and 6 is a bulkhead fitting 100. In some representative embodiments, bulkhead fitting 100 comprises a molded polymeric part for example molded of polymers such as polyester, polyethylene, polyamide, polypropylene, polycarbonate, polyphenylene oxide, urethanes, ABS and combinations thereof, as would be appreciated by those skilled in the art and all new polymers that may be subsequently developed that are capable of performing the same function. Alternative embodiments of bulkhead fitting 100 can comprise bulkhead fittings fabricated and/or cast of metals such as copper, brass or plated brass, stainless steel and other metals known to one of skill in the art. Bulkhead fitting 100 is generally defined by a first surface 102 and a second surface 104. First surface 102 and second surface 104 are both bounded by a perimeter surface 106. Although perimeter surface 106 is shown having a square shape, it is to be understood that perimeter surface 106 can comprise any suitable geometric shape including, such as, for example, triangular, circular, rectangular or any other geometric shape or even non-geometric shape that proves capable of performing satisfactorily in the environment of use.

As illustrated in FIGS. 1 and 5, first surface 102 comprises an inlet port 108, a pair of outlet ports 110a, 110b, and a bulkhead bore 112. A tube fitting 114 fluidly connects and seals the inlet port 108 with a length of inlet tubing 116, the outlet port 110a with a length of outlet tubing 118a and the outlet port 110b with a length of outlet tubing 118b. Tube fitting 114 can be operatively attached to the appropriate port using a suitable joining technique such as, for example, those disclosed in U.S. patent application Ser. Nos. 10/124,847, 10/167,046, 10/210,776 and 10/412,050 each of which is herein incorporated by reference to the extent not inconsistent with the present disclosure as well as other suitable techniques, such as, for example, heat bonding, adhesive bonding, sonic welding and spin welding and combinations thereof, as would be appreciated by those skilled in the art and all new joining techniques that may be subsequently developed that are capable of performing the same function.

As illustrated in FIGS. 2 and 4, second surface 104 comprises a filtration inlet port 120, a pair of filtration outlet ports 122a, 122b and a pair of electrical connectors 124a, 124b. Electrical connectors 124a, 124b are mounted over bulkhead bore 112 such that a pair of wire pairs 126a, 126b can extend through the bulkhead bore 112 to first surface 102 while the wire pairs 126a, 126b are electrically connected to a pair of electrical plugs 128a, 128b.

As shown in FIG. 6, bulkhead fitting 100 comprises a series of features whereby first surface 102 and second surface 104 are in operable communication. For instance, a bulkhead outlet flow circuit 130 is defined between the filtration outlet port 122b and the outlet tubing 118b. Though not depicted, it will be understood by one of skill in the art that a similar bulkhead outlet flow circuit is defined between the filtration outlet port 122a and outlet tubing 118a. Similarly, a bulkhead inlet flow circuit is defined between the inlet tubing 116 and the filtration inlet port 120. In addition to being fluidly connected, first surface 102 and second surface 104 are electrically interconnected through the interconnection of wire pair 126b with electrical plug 128b. Though not depicted, it will be easily understood by one of skill in the art that wire pair 126a is similarly interconnected with electrical plug 128a.

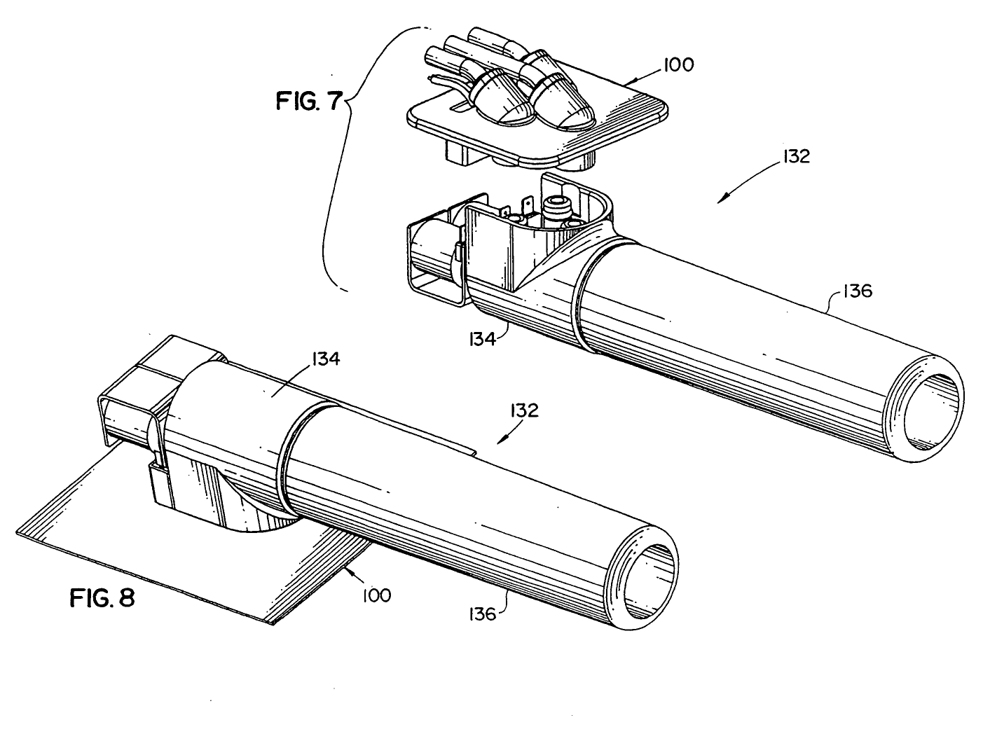

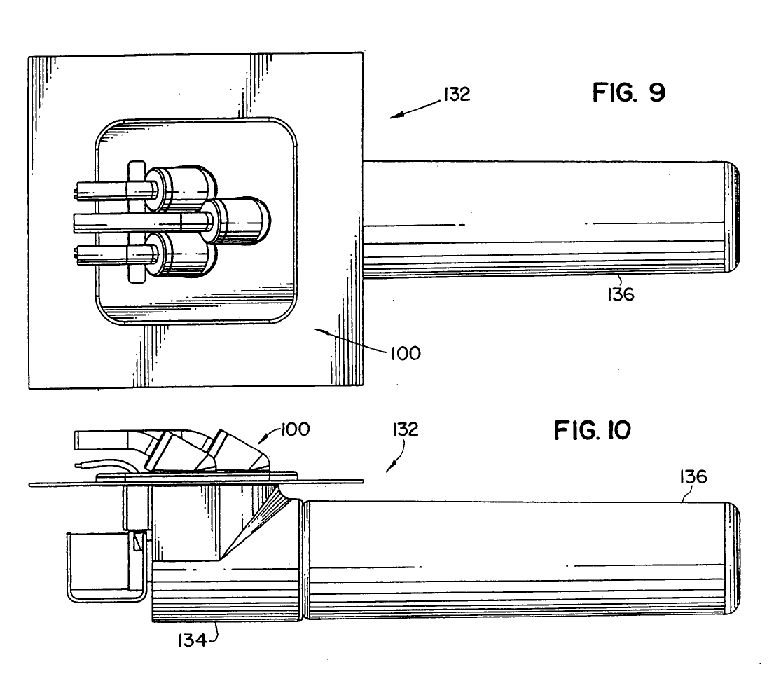

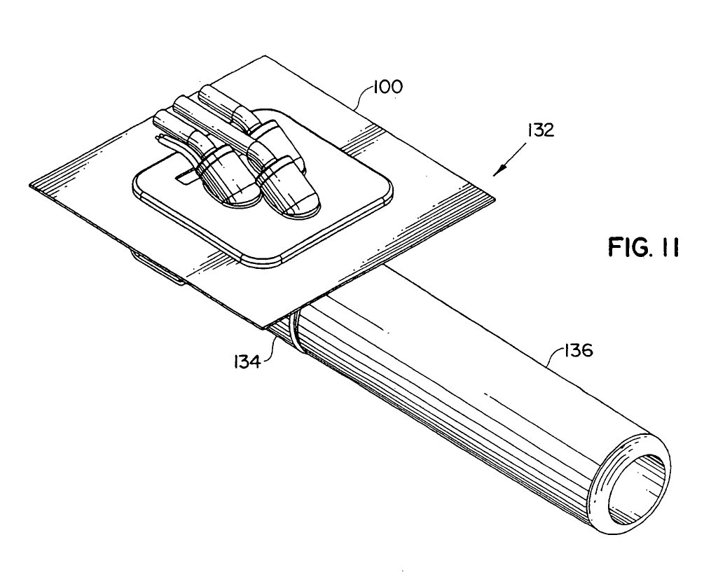

In some representative embodiments, bulkhead fitting 100 can attach to a water filtration system 132 as shown in FIGS. 7, 8, 9, 10 and 11. For instance, in some representative embodiments, water filtration system 132 can comprise, in addition to bulkhead fitting 100, a manifold assembly 134 and a cartridge filter 136. Water filtration system 132 can comprise alternative configurations such as, for example, as described in U.S. Pat. No. 6,027,644 to Magunuson et al., entitled “Dripless Purification Manifold and Cartridge”, U.S. Pat. No. 6,632,355 to Fritze, entitled “Low Spillage Replaceable Water Filter Assembly”, U.S. Pat. No. 6,649,056 to Fritze, entitled “Filter Assembly”, as well as copending U.S. patent application Ser. No. 10/445,372, entitled “Water Filter Assembly,” all of which are herein incorporated by reference to the extent not inconsistent with the present disclosure. Similarly, cartridge filter 136 can take a variety of alternative configurations such as, for example, configurations as described and disclosed in the above incorporated disclosures as well as configurations described in copending U.S. patent application Ser. Nos. 09/618,686, 09/929,920, 10/196,340, 10/202,290 and 10/406,637, each of which are incorporated herein by reference to the extent not inconsistent with the present disclosure. It will be further understood by one of skill in the art that manifold assembly 134 can be adapted to accommodate a plurality of cartridge filters 136, either in parallel or series arrangement, without departing from the spirit and scope of the present disclosure.

Manifold assembly 134 and cartridge filter 136 can be adapted such that cartridge filter 136 is selectively removable and/or attachable to manifold assembly 134. For example, manifold assembly 134 and cartridge filter 136 can be configured to allow for rotatable interconnection of the cartridge filter 136 to the manifold assembly 134 through the use of elements such as helical ramps, angled tabs and corresponding receivers as described and illustrated in the previously incorporated disclosures. Alternatively, manifold assembly 134 and cartridge filter 136 can be operably connected through a slidable engagement mechanism as described and illustrated in copending U.S. patent application Ser. No. 10/210,890, which is herein incorporated by reference to the extent not inconsistent with the present disclosure. In addition, manifold assembly 134 and cartridge filter 136 may be operably connected through the use of an adapter such as, for example, the adapter described in U.S. Pat. No. 6,360,764 to Fritze, entitled “Cartridge Adapter”, and U.S. Pat. No. 6,426,001 to Fritze, entitled “Cartridge Adapter”, each of which is incorporated by reference to the extent not inconsistent with the present disclosure.

In some presently preferred representative embodiments, cartridge filter 136 comprises a unitary, pre-packaged assembly providing for quick and easy removal and installation of cartridge filter 136 with respect to manifold assembly 134. Cartridge filter 136 generally comprises a cartridge housing and an internal filtration media of the type known by those of skill in the art for removing contaminants and purifying water. The cartridge housing can be constructed of polymeric materials such as, for example, polyester, polyethylene, polyamide, polypropylene, polycarbonate, polyphenylene oxide, urethanes, ABS and combinations thereof, as would be appreciated by those skilled in the art and all new polymers that may be subsequently developed that are suitable housing materials. Examples of suitable filtration media can include powdered and granular activated carbon media, ceramic filtration media, powdered polymeric filtration media, manganese greensand, ion exchange media, cross-flow filtration media, polymeric barrier filtration or media, mineral-based fibers, granules and powders and combinations thereof, as would be appreciated by those skilled in the art and all new filtration media that may be subsequently developed that are capable of performing the same filtration function.

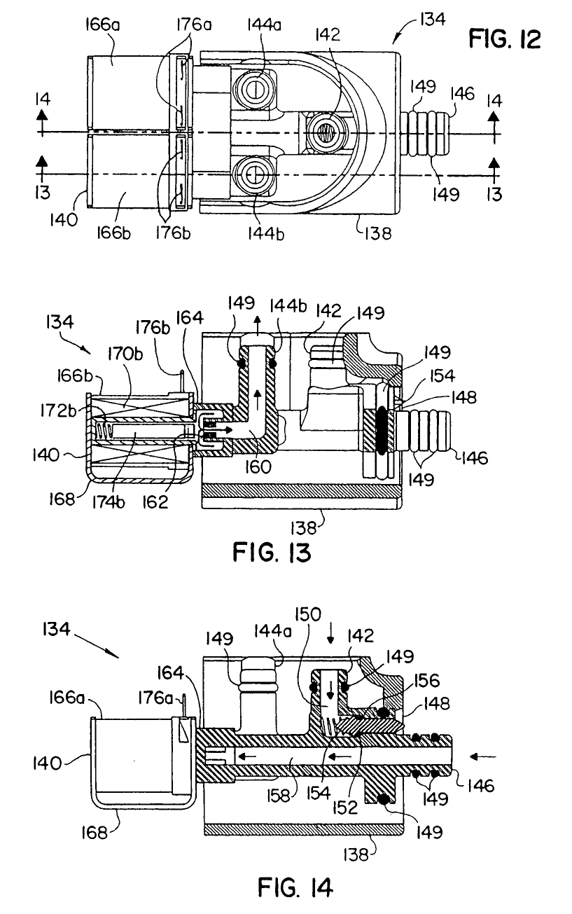

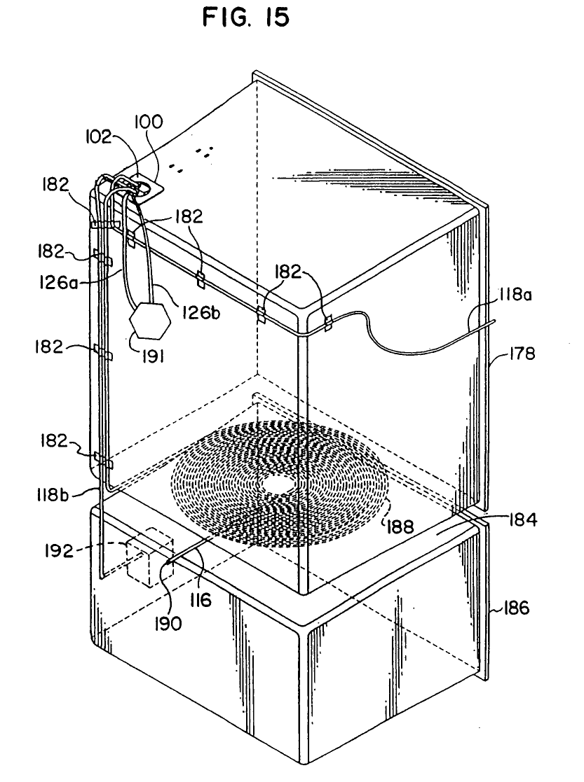

Manifold assembly 134 generally comprises a manifold body 138 and a valve assembly 140 as illustrated in FIGS. 12, 13 and 14. Manifold assembly 134 can be comprised of the same materials as previously described for the bulkhead fitting 100 and in some presently preferred representative embodiments, manifold assembly 134 and bulkhead fitting 100 comprise the same material of construction. As described and referenced below, manifold assembly 134, and especially manifold body 138, comprises a separable element from the bulkhead fitting 100 though it is contemplated and will be obvious to one of skill in the art that the manifold assembly 134 and bulkhead fitting 100 can be simultaneously formed as a single, unitary structure.

Manifold body 138 comprises an unfiltered manifold inlet port 142, a pair of filtered manifold outlet ports 144a, 144b, a filtered manifold inlet port 146 and an unfiltered manifold outlet port 148. The various inlet and outlet ports can include one or more port seals 149 such as, for example, o-ring seals. An unfiltered manifold flow channel 150 is defined between the unfiltered manifold inlet port 142 and the unfiltered manifold outlet port 148. Unfiltered manifold flow channel 150 comprises an inlet valve seat 152 operably interfacing with an inlet spring valve 154. Inlet spring valve 154 can comprise a spring valve seal 156 such as, for example, an o-ring, allowing inlet spring valve 154 to sealingly close the unfiltered manifold flow channel 150. A filtered manifold flow channel 158 is defined between the filtered manifold inlet port 146 and the filtered manifold outlet ports 144a, 144b. Filtered manifold flow channel 158 is branched into a pair of filtered distribution flow channels 160, each distribution flow channel 160 in fluid communication with one of the filtered manifold outlet ports 144a, 114b. Each filtered distribution flow channel 160 comprises an outlet valve seat 162 and a valve port 164.

Valve assembly 140 can comprise a pair of solenoid valves 166a, 166b and a mounting bracket 168. Solenoid valve 166b comprises a coil 170b, a spring 172b and a valve plunger 174b. Coil 170b is electrically interconnected to a plug connector 176b. Though not depicted, it is to be understood that solenoid valve 166a similarly comprises a coil, a spring and a valve plunger in addition to a plug connector 176a shown in FIG. 12. While valve assembly 140 is described with respect to solenoid valves 166a, 166b, it is to be understood that other alternative suitable valve configurations such as, for example, pneumatic, hydraulic or alternative electrically actuated valves can be used in place of solenoid valves 166a, 166b. Mounting bracket 168 is coupled to manifold body 138 so as to position valve plunger 174b and the non-depicted valve plunger of solenoid valve 166a with respect to valve ports 164. Mounting bracket 168 can be removably attached to the manifold body 138 through the use of fasteners such as, for example, screws or may be fabricated as an integral component of the manifold body 138.

While the representative embodiments in FIGS. 1-14 have a particular form of the bulkhead connector for connection to a filter manifold, additional components of the manifold can be moved within the foamed-in-place unit. For example, if the valves can be incorporated into the insulated unit, the output branch and/or valves can be also removed from the appliance cavity. In another example, the bulkhead connection may simply be a connector for the filter cartridge or the like. A common feature of these and other related representative embodiments is that the tubing runs within the insulating unit in contrast with systems in which the tubing passes through a hole in the insulating structure to pass from one side to the other.

With respect to the representative embodiments of FIGS. 1-14, one representative first step in installing water filtration system 132 in an appliance is to mount the bulkhead fitting 100 and the inlet tubing 116 and outlet tubing 118a, 118b. As illustrated in FIG. 15, bulkhead fitting 100 is positioned and mounted in an opening in a refrigeration liner 178. Though bulkhead fitting 100 is depicted as mounted in the top surface of refrigeration liner 178, bulkhead fitting 100 can be similarly mounted within any other surface such as, for example, a bottom surface, the side surfaces or the rear surface. Similarly, the orientation of bulkhead fitting 100 on the selected surface can be any suitable orientation. Prior to incorporation into the insulation material, bulkhead fitting 100 can be positioned in refrigeration liner 178 with a suitable attachment method such as, for example, taping, rotatably interlocking, snap-fit interlocking, adhesively joining for example using a pressure sensitive adhesive foam gasket or caulk, clamping and combinations thereof, as would be appreciated by those skilled in the art and all new positioning techniques that may be subsequently developed that are capable of performing the same function. As shown in FIG. 15, bulkhead fitting 100 is positioned such that first surface 102 corresponds to an exterior surface 180 of the refrigeration liner. Inlet tubing 116 and outlet tubing 118a, 118b are routed and can be taped with tape 182 in desired locations on the exterior surface 180. For instance, inlet tubing 116 is routed down the rear wall of refrigeration liner 178 and directed into a mullion partition 184 between the refrigeration liner 178 and a freezer liner 186. Inlet tubing 116 is shown in a spiraled orientation to form a coil tank 188 and is then directed toward the rear wall to define an inlet connection 190. In addition, wire pairs 126a, 126b can be similarly positioned along exterior surface 180 for subsequent connection to an input source 191 such as, for example, a microprocessor, PLC (Programmable Logic Controller), a relay circuit or a terminal strip, as would be known to those skilled in the art. Coil tank 188 can functions as a storage tank wherein a desired volume of unfiltered water is pre-chilled prior to filtration. Coil tank 188 can be optimally positioned within the mullion partition 184 such as, for example, near the freezer liner 186 such that the unfiltered water within the spiraled storage orientation is exposed to cooler temperatures. Outlet tubing 118b is similarly taped into position and routed along the rear walls of the refrigeration liner 178 and freezer liner 186 wherein the outlet tubing 118b can be directed into an interior portion of the freezer liner 186 for interconnection to an automated icemaker 192. Outlet tubing 118a is similarly taped into position along the rear and side wall of the refrigeration liner 178. Outlet tubing 118a can subsequently be connected to a water tap mounted in either the interior of the refrigeration liner 178 or the in the subsequently attached refrigerator door for providing on-demand filtered water.

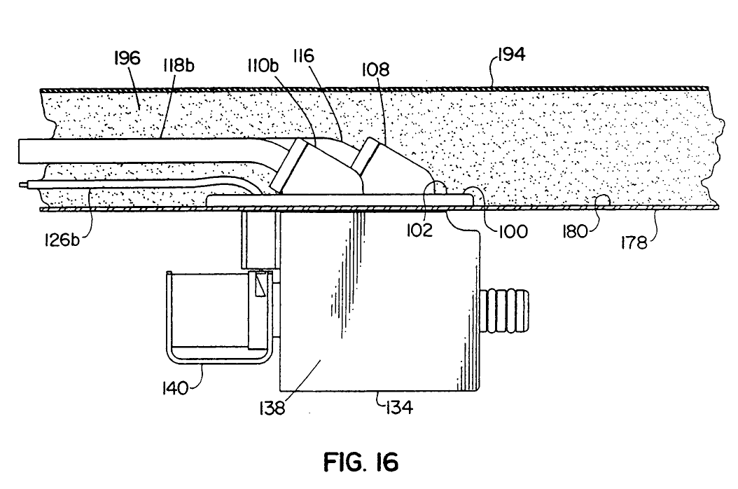

Once the bulkhead fitting 100, inlet tubing 116, outlet tubing 118a, 118b and wire pairs 126a, 126b are positioned, the appliance insulation can be added. Current methods of manufacturing refrigeration appliances such as, for example, refrigerators, includes foaming-in-place inner liners, for example refrigeration liner 178 or freezer liner 186, with respect to an exterior appliance wall 194 as shown in FIG. 16. A foam 196 operative positioned between the refrigeration liner 178 and the exterior appliance wall 194 serves a dual purpose of providing thermal insulation while operatively joining and positioning the refrigeration liner 178 as well as providing mechanical integrity and the exterior appliance wall 194 with respect to each other. Through the use of a foaming-in-place operation, the use of connectors and supports between the inner liner and the exterior wall can be reduced or eliminated serving to decrease the cost of these connections while also eliminating any thermal conduction through such connections. This foam-in-place operation, or the like, embeds the water system component, or portions thereof, within the foam such that there is intimate contact between the foam and the components and the component cannot be removed without destroying the structural integrity of the foam. Suitable foams include, but are not limited to, polyurethane foam and the like capable of performing the same function. Suitable foam-in-place methods and descriptions are disclosed, for example, in U.S. Pat. No. 2,552,641 to Morrison, entitled “Heat Insulated Container Having Foamed Plastic Insulation,” U.S. Pat. No. 3,440,308 to Carbary et al., entitled “Method of Making a Refrigerator Assembly”, U.S. Pat. No. 3,707,423 to Kitson, entitled “Refrigerator Cabinets”, U.S. Pat. No. 4,771,532 to Taylor, Jr. et al., entitled “Method of Assembling a Refrigerator”, U.S. Pat. No. 5,033,182 to Winterheimer et al., entitled “Method of Making a Refrigerator Cabinet,” and U.S. Pat. No. 5,704,107 to Schmidt et al., entitled “Refrigerator Door Construction,” all of which are incorporated herein by reference to the extent not inconsistent with the present disclosure.

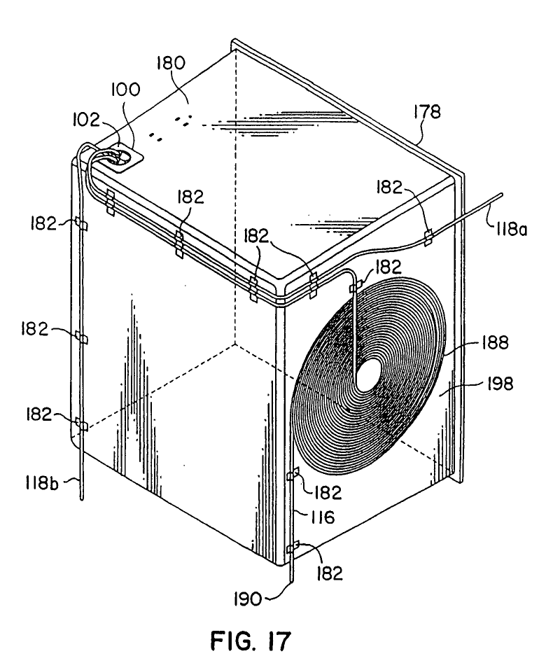

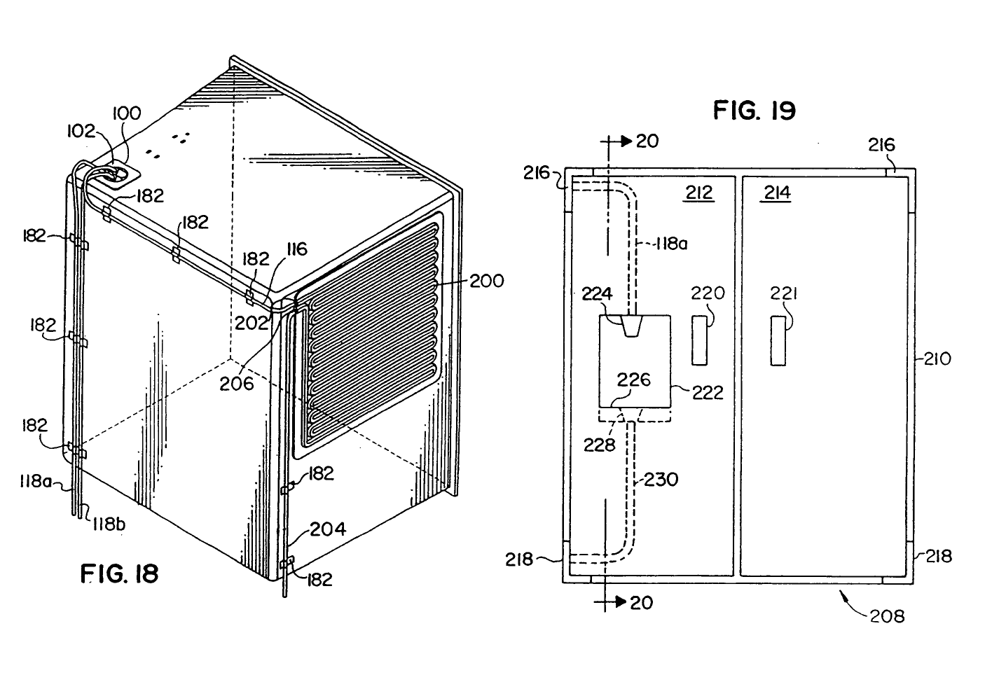

In mounting and positioning the bulkhead fitting 100, inlet tubing 116, outlet tubing 118a, 118b and wire pairs 126a, 126b prior to the foam-in-place operation, greater flexibility is provided with respect to where system components are positioned. For example, coil tank 188 can be positioned along a side wall 198 of the refrigeration liner 178 as shown in FIG. 17. In another alternative representative arrangement, a tank, such as, for example molded serpentine tank 200 can be mounted on side wall 198 such that inlet tubing 116 is routed into a tank outlet 202 and a supply tube 204 is routed to a tank inlet 206, as shown in FIG. 18. The use of molded serpentine tank 200 may be especially advantageous for side-by-side refrigerator/freezers in which the molded serpentine tank 200 cools the unfiltered water due to proximity to a freezer portion of the appliance. Advantageous designs for molded serpentine tank 200 are found in copending provisional patent application Ser. No. 60/591,646, filed Jul. 28, 2004 and entitled “Heat Exchanger and Liquid Reservoir”, which is herein incorporated by reference to the extent not inconsistent with the present disclosure. Other representative water tank designs can be similarly incorporated into the appliance partitions based on the disclosure herein. Other embodiments with different placement of the respective components and similarly, adaptation to systems with different relative placement, upper freezer or side-by-side configurations, can be accomplished by a person of ordinary skill in the art based on the disclosure herein.

Once the foam-in-place operation is complete, the various operational connections can be completed. For example, inlet connection 190 can be connected to a water source, outlet tubing 118a can be connected to the automated icemaker 192, outlet tubing 118b can be connected to a water tap, and wire pairs 126a, 126b can be electrically connected to the input source 191.

Following the completion of the operational connection, manifold assembly 134 can be sealingly coupled to the bulkhead fitting 100. Manifold assembly 134 is oriented such that the components of the manifold body 138 and valve assembly 140 are aligned with the corresponding components of the bulkhead fitting 100. For example, unfiltered manifold inlet port 142 is aligned with filtration inlet port 120, filtered manifold outlet port 144a is aligned with the filtration outlet port 122a, filtered manifold outlet port 144b is aligned with the filtration outlet port 122b, plug connector 176a is aligned with electrical plug 128a and plug connector 176b is aligned with electrical plug 128b. Once manifold assembly 134 is properly aligned with bulkhead fitting 100, manifold assembly 134 is slidingly attached to bulkhead fitting 100 such that fluid circuits are defined between the unfiltered manifold inlet port 142 and the filtration inlet port 120, filtered manifold outlet port 144a and the filtration outlet port 122a and filtered manifold outlet port 144b and filtration outlet port 122b. As the manifold assembly 134 is attached to the bulkhead fitting 100, port seals 149 are compressed such that the fluid circuits are operatively sealed. At the same, the connection of plug connector 176a and electrical plug 128a as well as the connection of plug connector 176b and electrical plug 128b electrically interconnect the wire pairs 126a, 126b with the corresponding solenoid valve 166a, 166b. Once connected, suitable fasteners, such as nuts and bolts, snaps, clamps and the like can be used to hold manifold assembly 134 in connection with bulkhead fitting 100.

Following the attachment of manifold assembly 134 to the bulkhead fitting 100, cartridge filter 136 can be attached such as, for example, rotatably or slidingly to the manifold 134 such that the unfiltered manifold outlet port 148 is fluidly connected to the filtered manifold inlet port 146 through the cartridge filter 136 such as disclosed in the previously incorporated disclosures. As cartridge filter 136 is attached, a protruding element such as, fore example, a protruding tab or ramp on the cartridge filter 136 engages the inlet spring valve 154 causing the spring valve seal 156 to compress such that the inlet spring valve 154 is no longer seated against the inlet valve seat 152. As such, the attachment of the cartridge filter 136 defines a continuous fluid circuit from the inlet connection 190 to the distribution flow channels 160. More specifically, the continuous flow channel is defined through the inlet port 108, through the filtration outlet port 120 and into the unfiltered manifold flow channel 150 where the unfiltered water enters the cartridge filter 136. Within cartridge filter 136, the unfiltered water passes through the media whereby contaminants are removed and filtered water exits cartridge filter 136 and enters filtered manifold flow channel 158. The filtered water flows through filtered manifold flow channel 158 where it is subsequently divided into two streams at the distribution flow channels 160. Valve plunger 174b and the non-depicted valve plunger of solenoid valve 166a seat against outlet valve seats 162, thus preventing the filtered water from exiting the manifold assembly 134.

In operation, automated icemaker 192 or a user desiring drinking water from a water tap generates a signal to the input source 191 requesting the distribution of filtered water. For example, the in the case of automated icemaker 192 requesting filtered water, input source 191 energizes solenoid coil 170b via a signal through wire pair 126b, electrical plug 128b and plug connector 176b. When energized, solenoid coil 170b generates a magnetic field wherein valve plunger 174b is withdrawn from the outlet valve seat 162 causing compression of spring 172b. As such, the filtered water flows through the distribution flow channel 160, out the filtered manifold outlet port 144b, into the bulkhead fitting 100 through and filtration outlet port 122b, and to outlet tubing 118b through outlet port 110b wherein outlet tubing 118b delivers the filtered water to automated icemaker 192. It will be understood by one skilled in the art that filtered water can be similarly delivered through outlet tubing 118a by energizing the coil of solenoid valve 166a with a signal through wire pair 126a.

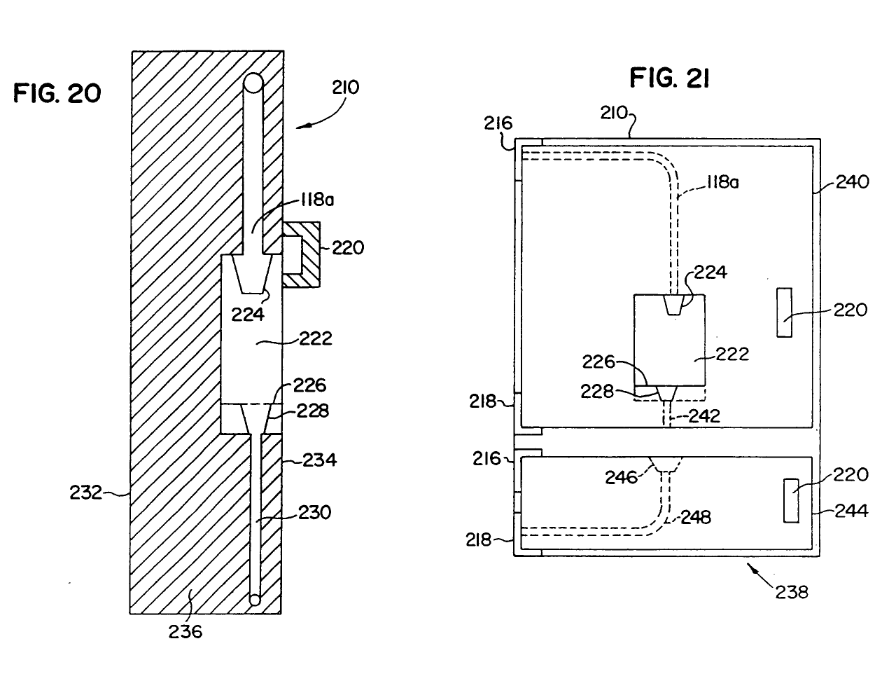

In addition to foaming-in-place the refrigeration liner 178 and freezer liner 186 with respect to the exterior appliance wall 194, an appliance door can be similarly constructed so as include components of the water filtration system 132. For example, FIG. 19 depicts a side-by-side refrigerator/freezer 208. Side-by-side refrigerator freezer 208 comprises an appliance body 210, a refrigerator door 212 and a freezer door 214. Both refrigerator door 212 and freezer door 214 are operably mounted to appliance body 210 using an upper hinge assembly 216 and a lower hinge assembly 218. Refrigerator door 212 and freezer door 214 each include a door handle 220, 221, respectively. Operatively mounted within refrigerator door 212 is a filtered water dispenser 222. Filtered water dispenser 222 can comprise a water tap 224, a perforated floor 226 and a drain 228. Outlet tubing 118b can be foamed-in-place within the appliance body 210 as previously described and routed through the upper hinge assembly 216 on refrigerator door 212. Outlet tubing 118b can be operably coupled to water tap 224 to supply filtered water from water filtration system 132. Any spilled or overflow water can drip through perforated floor 226 into the drain 228 wherein it is disposed of through drain tubing 230. Drain tubing 230 can be routed through the lower hinge assembly 218 to a suitable location for disposal of the excess water such as, for example, a household drain or to an evaporation tray within the appliance body 210. As illustrated in FIG. 20, refrigerator door 210 comprises an inner door skin 232, an outer door skin 234 and insulating foam 236.

In another alternative representative arrangement, a top and bottom refrigerator/freezer 238 can similarly comprise filtered water dispenser 222. Top refrigerator door 240 can include outlet tubing 118a foamed-in-place as previously described and connected to water tap 224. Top refrigerator door 240 can comprise an upper drain tube 242 while a lower refrigerator door 244 comprises a catch basin 246 fluidly coupled to a lower drain tube 248. Excess or overflow water can flow through the perforated floor 226 and into drain 228 wherein upper drain tube 242 directs the water to a location above the catch basin 246. Water drips out of upper drain tube 242, into catch basin 246 wherein the water can be disposed of through lower drain tube 248. Thus, a continuous drain path is formed through both the refrigerator and freezer doors. The control system of the dispenser can be designed to prevent flow from dispenser 224 when either of the doors are open, which may be indicated through the use of suitable switches and/or proximity sensors mounted within the appliance body 210.

As understood by those skilled in the art, additional representative embodiments may be practiced within the scope and intent of the present disclosure of the invention. The representative embodiments described above are intended to be illustrative and not limiting. Additional representative embodiments are intended to be within the scope of the appended claims. Although the present invention has been described with reference to particular embodiments, workers skilled in the art will recognize that changes may be made in form and detail without departing from the spirit and scope of the appended claims.

1. An appliance comprising:
an appliance body having a first wall, a second wall and insulation between the first wall and second wall; and
a water filtration system including a water flow component or a portion thereof embedded within the insulation.

2. The appliance of claim 1 wherein the water flow component is selected from the group comprising:
a filtration manifold, a bulkhead fitting, a storage tank, an inlet flow line, an outlet flow line, an inlet valve, an outlet valve, a wire assembly, a heat exchanger and a control unit.

3. (canceled)

4. The appliance of claim 1 further comprising:
at least one appliance door wherein the appliance door includes an inner door skin, an outer door skin and door insulation.

5. The appliance of claim 4 wherein the appliance door comprises:
a filtered water line, a drain line and a water dispenser embedded within the door insulation.

6. The appliance of claim 1 wherein the water filtration system comprises:
a water filter manifold having a filter connector, the water manifold being operably connected to the embedded water filtration component using a bulkhead fitting mounted to the first wall of the appliance body.

7. The appliance of claim 6 wherein the water filtration system further comprises:
a cartridge filter, wherein the cartridge filter is attached to the filter connector to define a filtering circuit connecting an inlet line and an outlet line of the water filter manifold through the cartridge filter.

8. The appliance of claim 7 wherein the cartridge filter is reversibly, rotatably attached to the filter connector.

9. The appliance of claim 1 wherein the appliance comprises:
a refrigerator having a refrigeration compartment and a freezer compartment.

10. The appliance of claim 9 wherein the refrigerator compartment is adjacent the freezer compartment and wherein the insulation separates the refrigerator compartment from the freezer compartment.

11-12. (canceled)

13. The appliance of claim 1 wherein the water filtration system further comprises:
a control unit operably connected to a valve, the control unit selectively controlling a filtered water flow through the water filtration system to a point-of-use.

14. (canceled)

15. A water filtration system for use with an insulated appliance comprising:
a filtration manifold and a cartridge filter, the cartridge filter operably connected to the filtration manifold such that a filtration circuit is defined between a manifold inlet and a manifold outlet wherein at least one water flow component or a portion thereof is embedded within an insulating structure.

16. The water filtration system of claim 15 wherein the at least one water flow component is selected from the group comprising:
a filtration manifold, a bullhead fitting, a storage tank, an inlet flow line, an outlet flow line, an inlet valve, an outlet valve, a wire assembly, a heat exchanger and a control unit.

17. The water filtration system of claim 15 wherein the filtration manifold comprises:
a filter connector providing for reversible, rotatable interconnection of the cartridge filter and the filtration manifold.

18. The water filtration system of claim 15 wherein the cartridge filter comprises a filtration media selected from the group comprising:
a powdered activated carbon media, a granular activated carbon media, a ceramic filtration media, a powdered polymeric filtration media, a manganese greensand filtration media, an ion exchange media, a cross flow filtration media, a polymeric barrier filtration, a, mineral-based fiber filtration media, a mineral-based granular filtration media and a mineral-based powder filtration media.

19. (canceled)

20. A method for installing a water filtration unit comprising the acts of:
providing an appliance suitable for incorporation of an insulated structural component; and
embedding at least one water flow component or portion thereof within the insulated structural component.

21. The method of claim 20 wherein the at least one water flow component is selected from the group comprising:
a water filter manifold, a bulkhead fitting, a storage tank, an inlet flow line, an outlet flow line, an inlet valve, an outlet valve, a heat exchanger, a control unit and a wire assembly.

22. The method of claim 20 wherein the insulated structural component is selected from the group comprising:
a wall, a door, a mullion partition and an insulation sheet.

23. The method of claim 20 wherein the at least one filtration component or portion thereof is selected from the group comprising:
an inlet line, an outlet line and a bulkhead fitting.

24-25. (canceled)

26. The method of claim 25 further comprising the act of:
installing a control unit within the insulated appliance, the control unit being operably connected to the water filtration system for selectively directing a water flow to the point-of-use.

27. (canceled)

28. The method of claim 20 wherein embedding the at least one water flow component further comprises the acts of:
positioning a liner and a wall within a form, and
applying insulation to embed the at least one water flow component or portion thereof in a fixed position relative to the liner and the wall.

29-31. (canceled)
